(19) United States
(12) Patent Application Publication
(10) Pub. No.: US 2003/0065108 A1
(43) Pub. Date: Apr. 3, 2003

(54) Thermoplastics with improved low temperature impact resistance

(76) Inventors: Jeffery Kurtis Beach, Norton, OH (US); Igor Chorvath, Midland, MI (US); Kevin Edward Lupton, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 10/251,205

(22) Filed: Sep. 20, 2002

Related U.S. Application Data
(60) Provisional application No. 60/324,126, filed on Sep. 21, 2001.

(51) Int. Cl. C08G 77/00

(52) U.S. Cl. 525/474

(57) ABSTRACT

Polymer compositions having improved impact resistance at temperatures below 10° C. comprising a polycarbonate resin and a polyorganosiloxane, and methods for their preparation, are disclosed.

### CROSS-REFERENCE

This application is related to and claims priority of U.S. Provisional Patent Application Serial No. 60/324,126, filed Sep. 21, 2001.

### FIELD OF THE INVENTION

This invention relates to improving low temperature impact strength of thermoplastic resins, especially thermoplastic polycarbonate resins by the addition of a polyorganosiloxane. More particularly, this invention relates to polymer compositions having improved impact resistance at temperatures below 10° C. comprising a polycarbonate resin and a polyorganosiloxane and methods for making such compositions.

### BACKGROUND OF THE INVENTION

Polycarbonates represent an important industrial class of thermoplastics resins that are commonly used in numerous engineered plastic products. Since their inception, ways have been sought to improve the low temperature impact performance of polycarbonate resins, in other words to “toughen” the polycarbonate resin, making it less brittle at low temperatures. Representative examples that describe various modified polycarbonate compositions are summarized below.

U.S. Pat. No. 5,981,661 describes a thermoplastic resin molding composition comprising a polyester and polycarbonate blend modified with an organopolysiloxane-polycarbonate and a glycidyl ester.

DE 19933129 A1 describes aromatic polycarbonates modified with aspartate ester-functional silicones.

U.S. Pat. No. 4,138,379 teaches a stabilized and plasticized polycarbonate composition comprising in admixture, an polycarbonate polymer and a stabilizing amount of essentially monomeric organic silane.

U.S. Pat. No. 5,548,011 teaches blends of polycarbonates, branched, phenolic hydroxy functional dimeric fatty acid polyesters and at least one component selected from polyisobutylene, silicones, and mineral oils.

While these references represent advances in the art, a need still exists for simple, cost effective solutions, to provide polycarbonate compositions having improved impact resistance at low temperatures.

### SUMMARY OF THE INVENTION

The present invention provides a thermoplastic resin composition comprising;

(A) 85 to 99% of a thermoplastic polycarbonate resin,

(B) 1 to 15% of a polyorganosiloxane having the formula;

(R′₃SiO_{½})ₓ(R′₂SiO_{2/2})_{y}(R′SiO_{3/2})_{z}

wherein x and y are positive numerical values and z is 0 or a positive numerical value with the provisos that x+y+z=1, y/(x+y+z)≧0.8 and R′ is a functional or nonfunctional, substituted or unsubstituted organic group, and (A)+(B) is 100, and said composition has an average notched Izod impact strength as determined by ASTM 256-97 Method A at −40° C. that is at least 100% increased vs. the value of the thermoplastic polycarbonate resin (A) alone.

The thermoplastic resin compositions having improved low-temperature impact resistance of the present invention are prepared by mixing a polycarbonate resin, above the melt point of thermoplastic, with a polyorganosiloxane. Mixing is typically done by extrusion, and the resulting compositions can be fabricated into plastic parts by conventional techniques, such as extrusion, injection molding, or compression molding. Furthermore, the composition of the present invention can be reprocessed or recycled, with little degradation of the physical properties.

The present invention also relates to a method for improving the impact resistance of a thermoplastic composition comprising; (I) preparing a masterbatch containing components (A) and (B), as defined supra, and (II) mixing the masterbatch with additional polycarbonate resin.

### DETAILED DESCRIPTION OF THE INVENTION

Component (A) of the present invention is a thermoplastic polycarbonate resin. As used herein, a thermoplastic polycarbonate resin means any polycarbonate compositions comprising a thermoplastic polycarbonate, blends of polycarbonates, and blends of polycarbonate with other thermoplastics. Suitable thermoplastic polycarbonates and methods of making polycarbonate resins are well known in the art, see, generally, U.S. Pat. No. 3,169,121, U.S. Pat. No. 4,487,896, and U.S. Pat. No. 5,411,999, the respective disclosures of which are each incorporated here by reference.

Polycarbonate resins are, in general, prepared by reacting a dihydric phenol, e.g. hydroquinone, resorcinol, 4,4′-dihydroxydiphenol, 2,2-bis-(4-hydroxyphenyl)-propane (bisphenol A), 2,4-bis-(4-hydroxyphenyl)-2-methylbutane, 2,2-bis-(4-hydroxy-3,5-dimethylphenyl)-propane, 1,1-bis-(4-hydroxyphenyl)-cyclohexane or 1,1-bis-(4-hydroxyphenyl)-3,3,5-trimethylcyclohexane, with a carbonate precursor, e.g. carbonyl chloride, a halogen formate, a bis-aloformate of dihydric phenol, or a carbonate ester, e.g. diphenyl carbonate, dichlorphenyl carbonate, dinaphtyl carbonate, phenyl tolyl carbonate, and ketolyl carbonate.

Typically, the polycarbonate resin comprises one or more resins selected from linear aromatic polycarbonate resins, branched aromatic polycarbonate resins, and poly(ester-carbonate) resins.

Suitable linear aromatic polycarbonates resins include e.g. bisphenol A polycarbonate resin. Suitable branched aromatic polycarbonates are made, e.g. by reacting a polyfunctional aromatic compound e.g trimellitic anhydride, trimellitic acid, trimesic acid, trihydroxy phenyl ethane, or trimellityl trichloride, with a dihydric phenol and a carbonate precursor to form branching polymers. Suitable poly(ester-carbonate) copolymer are made, e.g., by reacting a difunctional carboxylic acid, terepthalic acid, isophthalic, acid, 2,6-naphthalic acid, or mixtures of acid, or a derivative of a difunctional carboxylic acid, e.g. an acid chloride, with a dihydric phenol and a carbonate precursor.

Typically, the polycarbonate resin according to the invention has a melt-flow value ranging from 3 to 22 grams/10 minutes, as measured by ASTM D 1238 at 300° C., using a 1.2 kg sample.

Representative, non-limiting examples of suitable polycarbonate resins useful as component (A) in the present invention include the commercially available polycarbonates marketed under the tradenames: CALIBRE by the Dow Chemical Co. (Midland, Mich.), for example, CALIBRE 301-15, CALIBRe 200-14, and CALIBRE 201-15; LEXAN by General Electric (Pittsfield, Mass.); MAKRDON by Bayer A G (Leverkusen, Germany); LUSTRA by DSMEP (Dutch State Mine Engineering Plastics, Evansville, Ind.).

The polyorganosiloxane (B) of the present invention is a high viscosity polyorganosiloxane fluid or gum. As used herein, the term “fluid” describes a predominantly linear polyorganosiloxane polymer, for example polydimethylsiloxane. The term “fluid” is used in this sense even if the linear polymer contains a minor amount of branched chains or if, at room temperature, the material appears as more of a gum or solid. In other words, the term “fluid” describes only the predominantly linear characteristics of the polymer. Polyorganosiloxane fluids, then, can be defined as being of the general formula:

(R′₃SiO_{½})ₓ(R′₂SiO_{2/2})_{y}(R′SiO_{3/2})_{z}

wherein x and y are positive numerical values and z is 0 or a positive numerical value with the provisos that x+y+z=1, y/(x+y+z)≧0.8 and R′ is a functional or nonfunctional, substituted or unsubstituted organic group. It will be understood that polyorganosiloxane fluids or gums may also include reactive or functional groups.

The polyorganosiloxane (B) of the present invention typically has a number average molecular weight (Mn) of at least 10,000, but preferably below 1,000,000. Preferably, the Mn of component (B) is 40,000 to 400,000, more preferably 75,000 to 400,000. When the molecular weight is below 10,000 the improved thermoplastic resins tend to exhibit excessive screw slip. On the other hand, when the molecular weight is above 1,000,000, mixing the polyorganosiloxane into the thermoplastic becomes difficult, but such a polyorganosiloxane could still be employed. It is preferred that component (B) is a gum having Mn in the approximate range of 100,000 to 400,000 and most preferably 250,000 to 350,000.

Component (B) may be a linear or branched polymer or copolymer wherein the organic groups, R′, are independently selected from methyl, vinyl, hexenyl, or phenyl radicals. Most preferably, it is a polydimethylsiloxane homopolymer having dimethylhydroxysiloxy end groups. Component (B) is well known in the art and many such polymers and copolymers are available commercially. However, in the usual commercial preparation of these polymers, a considerable amount of low molecular weight cyclic polyorganosiloxane species is formed. For the purposes herein, it is preferred that these cyclics be removed (e.g., by stripping at elevated temperatures and/or reduced pressure) since they generally impart undesirable characteristics to the instant compositions and/or process. For example, the presence of cyclics can degrade the surface quality of the extrudate, generate foaming and/or smoke or it can increase the amount of screw slippage during extrusion.

Component (B) can be further combined with and optional component, a finely divided filler which is known to reinforce polyorganosiloxane and is preferably selected from finely divided, heat stable minerals such as fumed and precipitated forms of silica, silica aerogels and titanium dioxide having a specific surface area of at least about 50 m²/gram. The fumed form of silica is a preferred reinforcing filler based on its high surface area, which can be up to 450 m²/gram and a fumed silica having a surface area of 50 to 400 m²/g, most preferably 200 to 380 m²/g, is highly preferred. Typically, the fumed silica filler is treated to render its surface hydrophobic, as typically practiced in the silicone rubber art. This can be accomplished by reacting the silica with a liquid organosilicon compound which contains silanol groups or hydrolyzable precursors of silanol groups. Compounds that can be used as filler treating agents, also referred to as anti-creeping agents or plasticizers in the silicone rubber art, include such ingredients as low molecular weight liquid hydroxy- or alkoxy-terminated polydiorganosiloxanes, hexaorganodisiloxanes, cyclodimethylsilazanes and hexaorganodisilazanes. Alternatively, the treating compound is an oligomeric hydroxy-terminated diorganopolysiloxane having an average degree of polymerization (DP) of 2 to about 100, or alternatively 2 to 10, and it is used at a level of about 5 to 50 parts by weight for each 100 parts by weight of the silica filler.

The compositions of the present invention can be prepared by thoroughly dispersing from about 1 to 15 weight percent of polyorganosiloxane (B) in a thermoplastic polycarbonate resin (A), based on the total weight of (A) plus (B). It is preferred that about 3 to 6 weight percent (B) is used based on the weight of component (A) plus component (B). More preferably, about 4 to 5 weight percent (B) based on the weight of component (A) plus component (B) is used. When the polyorganosiloxane is added at levels below about 2 weight percent, there is little improvement in the low temperature impact resistance. Surprisingly, at levels higher than about 6 percent of (B) per 100 parts by weight of (A), the low-temperature impact resistance of the blend again begins to deteriorate. Additionally, at polyorganosiloxane levels above 6 percent the physical properties of the final extrudate at room temperature are degraded.

The thermoplastic resin compositions of the present invention have improved impact resistance at low temperatures (−10° C. or below) vs similar thermoplastic resin compositions that have not been modified with polyorganosiloxane (B), i.e. polycarbonate resins alone. For purposes of this invention, impact resistance is determined by ASTM 256-97, Standard Test Methods for Determining Izod Pendulum Impact Resistance of Plastics, Method A. The notched Izod impact strength is measured on a specimen having a length of 62 mm and a width of 3.5 mm and a thickness of 12.7 mm, according to American Society of Testing Materials (ASTM) method D 256-97 (Method A) at room temperature (approximately 25° C.). Briefly, this test measures the amount of energy required to break a notched specimen by a swinging pendulum hammer. Since such samples can develop heterogeneity (e.g., bubbles) during the molding process, for the purposes herein, at least 6 samples are tested, averaged and reported as energy absorbed per unit width.

Typically, compositions of the present invention have an average notched Izod impact strength at −40° C. of at least 133.5 J/m (2.5 ft-lbs/in), alternatively 267 J/m (5.0 ft-lbs/in), alternatively 427.2 J/m (8.0 ft-lbs/in), or alternatively 534.0 J/m (10.0 ft-lbs/in). Alternatively, the improvements in the low temperature impact strength of the compositions of the present invention, vs the same polycarbonate resin without any polyorganosiloxane (B) present, can be reported as a % increase at a given temperature. Typically, the present inventive compositions have an improved impact resistance at −40° C., as reported as an average notched Izod impact strength according to the methods described supra, that are 100%, alternatively 200%, or alternatively 300% increased vs. the unmodified polycarbonate resin.

Without being bound to any one theory, the inventors believe that the key parameters which determine the degree of impact improvement of a given polycarbonate system include; particle or void size created by the polyorganosiloxane, polyorganosiloxane concentration, distance between polyorganosiloxane particles or voids created with polyorganosiloxane addition, and the interfacial adhesion between the particles and the thermoplastic resin matrix.

The dispersion of polyorganosiloxane (B) into polycarbonate (A) may be accomplished by any of the traditional means for mixing additives into thermoplastic resin at elevated temperature. For example, the two components may be blended in a twin-screw extruder, a Banbury mixer, a two-roll mill or a single-screw extruder, either with or without a mixing head. The equipment used to mix these components is thus not critical as long as a uniform dispersion of (B) in (A) is attained. Preferably the dispersed particle size is no larger than about 10 micrometers, alternatively 1 micrometers, or alternatively 0.1 micrometers.

In addition to the above mentioned components (A) and (B), a minor amount (i.e., less than about 40 weight percent of the total composition, preferably less than 20 weight percent) of an optional additive may be incorporated in the compositions of the present invention. This optional additive can be illustrated by, but are not limited to, fillers, such as glass fibers and carbon fibers, quartz, talc, calcium carbonate, diatomaceous earth, iron oxide, carbon black and finely divided metals; lubricants; plasticizers; pigments; dyes; anti-static agents; blowing agents; heat stabilizers, such as hydrated cerric oxide; antioxidants; and fire retardant (FR) additives, such as halogenated hydrocarbons, alumina trihydrate, magnesium hydroxide and organophosphorous compounds. Useful stabilizers that can be optionally added to the compositions of the present invention are disclosed in U.S. Pat. No. 6,362,288, which is hereby incorporated by reference.

Specific non-limiting examples of the above additional ingredients include the following substances. Diatomaceous earth, octadecyl-3-(3,5-di-5-butyl 4-hydroxyphenyl)-propionate, bis(2-hydroxyethyl) tallowamine, calcium stearate, N,N-bis(2,2,6,6-tetramethyl-4-piperidinyl)-1,6-hexanediamine polymer with 2,4,6-trichloro-1,3,5-trizaine and 2,4,6-trichloro-1,3,5-trizaine and 2,4,4-trimethyl 1,2-pentanamine, dimethyl succinate polymer with 2,2,6,6-tetramethyl-1-piperridineethanol, 2,2-thiobis)4-tert-octylphenolato]n-butylamine nickel, tris(2,4-di-tert-butylphenyl)phoshite, bis(2,4-di-t-butylphenyl) pentaerythritol diphosphite, trisnonylphenylphospite, polyethylene glycol, Erucamide, titanium dioxide, titanium dioxide, alumina, hydrated alumina, talc, 2-hydroxy-4-n-octyloxy-benzophenone, zinc oxide, zinc sulfide and zinc stearate

Although it is possible to obtain a relatively uniform dispersion by injecting component (B) into the screw section of an extruder while thermoplastic polycarbonate pellets are fed in through the hopper thereof, it is preferred to first thoroughly disperse component (B) in a portion of component (A) to form a masterbatch. This masterbatch (or concentrate), which preferably contains about 10 to 60, more preferably 45 to 55, weight percent of the polyorganosiloxane, may be ground up or pelletized, the resulting particulate dry-blended with additional thermoplastic polycarbonate (the matrix) and this blend then extruded to form a composition of the invention. Typically, the use of this masterbatch technique results in a more uniform dispersion of the polyorganosiloxane in the polycarbonate matrix. A representative, non-limiting example of a commercial masterbatch suitable in the present invention is MB50-315 (Dow Corning Corporation, Midland, Mich.).

The polycarbonate used in the preparation of the above described masterbatch may be the same as, or different from, the matrix polycarbonate resin. Preferably, the two are of the same general type, e.g., bisphenol polycarbonate in the masterbatch and as the matrix.

The present invention further provides a method for improving the impact resistance of a polycarbonate resin comprising;

(I) preparing a masterbatch containing

(A) 40 to 90% of a thermoplastic polycarbonate resin,

(B) 10 to 60% of a polyorganosiloxane having the formula;

(R′₃SiO_{½})ₓ(R′₂SiO_{2/2})_{y}(R′SiO_{3/2})_{z}

wherein x and y are positive numerical values and z is 0 or a positive numerical value with the provisos that x+y+z=1, y/(x+y+z)≧0.8 and R′ is a functional or nonfunctional, substituted or unsubstituted organic group, and

(II) mixing the masterbatch with a polycarbonate resin.

The masterbatch can be prepared by mixing (A) a thermoplastic polycarbonate resin and (B) a polyorganosiloxane, both as defined supra, by any conventional mixing techniques. For example, the two components may be blended in a twin-screw extruder, a Banbury mixer, a two-roll mill or a single-screw extruder, either with or without a mixing head. The equipment used to mix these components is thus not critical as long as a uniform dispersion of (B) in (A) is attained. The masterbatch is then mixed with the polycarbonate resin, as defined supra by conventional mixing techniques. The ratio of the masterbatch to the additional polycarbonate resin can vary, but typically is selected so as to provide a final weight percent of polyorganosiloxane in the composition of 1 to 20 wt. %, alternatively from 3 to 10%, or alternatively from 3 to 5%. Typically, the mixing is conducted on an extruder, and more typically on a twin-screw extruder.

The compositions of the present invention are useful in a variety of applications where improved impact resistance of thermoplastics is desired. In particular, the compositions of the present invention are useful in the preparation of polycarbonate based articles of manufacture that can be used to replace metal based articles, and in particular where such replacements are sought in low temperature applications. Thus, the compositions of the present invention can be used for example in the construction of cable materials, telephone boxes, communication devices, and mailboxes.

### EXAMPLES

The following examples are presented to further illustrate the compositions and methods of this invention, but are not to be construed as limiting the invention. All parts and percentages in the examples are on a weight basis and all measurements were obtained at about 23° C., unless indicated to the contrary.

Materials

The following materials were employed in the examples.

MB50-315 is a commercially available master batch from Dow Corning Corporation (Midland, Mich.) consisting of 50% polycarbonate and 50% ultra high molecular weight polyorganosiloxane in pellet form.

PC1 is Dow CALIBRE 301-15, polycarbonate resin from Dow Chemical (Midland, Mich.).

PC2 is Dow CALIBRE 200-14, polycarbonate resin from Dow Chemical (Midland, Mich.).

PC3 is Dow CALIBRE 201-15, polycarbonate resin from Dow Chemical (Midland, Mich.).

### Example 1

Polyorganosiloxane Modified Polycarbonate Low Temperature Impact Analysis

Four samples of polycarbonate compositions were prepared using a 25 mm Werner and Pfleiderer twin screw extruder with the processing section heated to 240° C. to 260° C. and a screw speed of 250 rpm to 500 rpm at an output rate of 10 kg/hr to 20 kg/hr, according to the formulations as summarized in Table 1. Two samples were modified with a polyorganosiloxane by the addition of MB50-315, a 50/50 blend of a polycarbonate/polyorganosiloxane masterbatch product, commercially available from Dow Corning Corporation, (Midland Mich.). All samples were dried in a hot-air desiccant drier for 4 hours at 120° C. before use.

TABLE 1

| Sample # | Polycarbonate | Polyorganosiloxane Content |
|---|---|---|
| 1 | PC1 | 0% |
| 2 | PC1 | 6.25% |
| | | (12.5% MB50-315) |
| 3 | PC2 | 6.25% |
| | | (12.5% MB50-315) |
| 4 | PC2 | 0% |

The extrudate was cooled in a water bath and strand pelletized. Between each sample a purge was done on the extruder with the “new” sample to insure sample integrity.

The resulting extrudate samples were dried for 4 hours @120° C. in a hot-air desiccant drier. Each sample was molded using a 35 metric tons (39 ton), Hydraulic Injection Molding Unit. The mold was a tensile bar mold with four chambers, spaced 2 on each side of the sprue, of dimensions (L×W×D) 12.7 cm×1.27 cm×0.32 cm (5.0″×0.5″×0.125″). The specimen's were molded under the following conditions, with some minor variations made in shot size and hold pressure due to changes in flow characteristics from sample to sample. The tensile bars were cut to test specimen length using ASTM 256-97, Standard Test Methods for Determining Izod Pendulum Impact Resistance of Plastics, standards to 6.35 cm (2.5 in) with a radial arm saw and notched using a Testing Machines, Inc. (TMI) Model 22-05 Notching Cutter at maximum cutter speed (10) and maximum feed speed (10) according to ASTM 256-97 standards, width under notch=1.02 cm (0.40 in). The specimens then sat at room temperature (˜23 C.) and 45-55% relative humidity for 48 hours before evaluation.

Six test specimens were tested for each of the samples using ASTM 256-97, Method A, standards on a TMI Model 43-02 Monitor/Impact Tester employing a 4.54 kg (10 lb) pendulum. The impact tester is also fitted with a cold/heat chamber. Each set of the specimens was tested at room temperature (˜23 C.), −10 C., and −40 C. to determine the effect of polyorganosiloxane modification on polycarbonate at room and low temperatures. The specimens were given a nominal period of 3 minutes to cool at the low temperature settings in the cold chamber before the lid was lifted and the pendulum was immediately released. Carbon dioxide gas was used to cool the specimens and chamber. Table 2 summarizes the results of these tests:

TABLE 2
Notched Izod Impact Results

| | | | −10° C. | −40 C. |
|---|---|---|---|---|
| | % Poly- | RT Notched Izod | Notched Izod | Notched Izod |
| Sample | organo- | Impact Result | Impact Result | Impact Result |
| # | siloxane | J/m (ft-lbs/in) | J/m (ft-lbs/in) | J/m (ft-lbs/in) |
| 1 | 0 | 884.7 (16.572) | 144.4 (2.705) | 107.4 (2.012) |
| 2 | 6.25 | 661.9 (12.399) | 555.5 (10.405) | 488.3 (9.147) |
| 3 | 6.25 | 459.0 (8.597) | 374.9 (7.023) | 348.1 (6.521) |
| 4 | 0 | 847.2 (15.87) | 128.9 (2.414) | 106.8 (2.000) |

### Example 2

Modified Polycarbonate Low Temperature Impact Analysis at Varying Polyorganosiloxane Loading Levels.

Impact testing was done on a series of samples prepared with varying percentages of a polyorganosiloxane dispersed in a polycarbonate resin (PC 3), as summarized in Table 3. The samples were prepared on an extruder, according to the procedure described in Example 1. The polyorganosiloxane was dispersed as a masterbatch product (MB50-315 commercially available master batch product which is a pellet that is 50% commercially available PC and 50% ultra high molecular weight polyorganosiloxane). The loadings varied from from 0-40% of the master batch product giving an ultimate polyorganosiloxane content of 0-20% in the polycarbonate. The impact modification improvement was tested via the notched Izod impact, as described in Example 1. The results are summarized in Table 4.

The greatest impact improvement was found to be between 6-10 percent polycarbonate masterbatch which gives an ultimate polyorganosiloxane content of 3 to 5 percent polyorganosiloxane content in the PC

TABLE 3

| | % |
|---|---|
| Sample ID | Polyorganosiloxane |
| 5 | 0 |
| 6 | 1.0 |
| 7 | 2.5 |
| 8 | 4.0 |
| 9 | 5.0 |
| 10 | 6.25 |
| 11 | 10.0 |
| 12 | 15.0 |
| 13 | 20.0 |

TABLE 4
Notched Izod Impact Results

| | | | −10° C. | −40 C. |
|---|---|---|---|---|
| | % Poly- | RT Notched Izod | Notched Izod | Notched Izod |
| Sample | organo- | Impact Result | Impact Result | Impact Result |
| # | siloxane | J/m (ft-lbs/in) | J/m (ft-lbs/in) | J/m (ft-lbs/in) |
| 5 | 0 | 893.5 (16.737) | 149.4 (2.799) | 130.6 (2.446) |
| 6 | 1.0 | 776.7 (14.549) | 205.9 (3.857) | 136.6 (2.558) |
| 7 | 2.5 | 729.6 (13.667) | 609.7 (11.420) | 307.0 (5.801) |
| 8 | 4.0 | 675.3 (12.650) | 550.7 (10.315) | 513.7 (9.623) |
| 9 | 5.0 | 649.9 (12.174) | 580.2 (10.869) | 519.4 (9.729) |
| 10 | 6.25 | 524.2 (9.820) | 415.0 (7.773) | 394.0 (7.380) |
| 11 | 10.0 | 496.9 (9.308) | 363.6 (6.810) | 346.6 (6.492) |
| 12 | 15.0 | 379.5 (7.109) | 262.6 (4.918) | 249.0 (4.682) |
| 13 | 20.0 | 262.2 (4.912) | 189.4 (3.547) | 185.7 (3.478) |

We claim:

1. A thermoplastic resin composition comprising;
(A) 85 to 99% of a thermoplastic polycarbonate resin,
(B) 1 to 15% of a polyorganosiloxane having the formula;
(R′₃SiO_{½})ₓ(R′₂SiO_{2/2})_{y}(R′SiO_{3/2})_{z}
wherein x and y are positive numerical values and z is 0 or a positive numerical value with the provisos that x+y+z=1, y/(x+y+z)≧0.8 and R′ is a functional or nonfunctional, substituted or unsubstituted organic group and (A)+(B) is 100, and said composition has an average notched Izod impact strength as determined by ASTM 256-97 Method A at −40° C. that is at least 100% increased vs. the value of the thermoplastic polycarbonate resin (A) alone.

2. The thermoplastic resin composition of claim 1 wherein the polycarbonate resin comprises one or more resins selected from linear aromatic polycarbonate resins, branched aromatic polycarbonate resins, and poly(ester-carbonate) resins.

3. The thermoplastic resin composition of claim 1 wherein the polycarbonate resin has a melt-flow value ranging from 3 to 22 grams/10 minutes, as measured by ASTM D 1238 at 300° C., using a 1.2 kg sample.

4. The thermoplastic resin composition of claim 1 wherein the polyorganosiloxane (B) has a number average molecular weight (Mn) of at least 10,000.

5. The thermoplastic resin composition of claim 1 wherein the number average molecular weight (Mn) of the polyorganosiloxane (B) is 40,000 to 400,000.

6. The thermoplastic resin composition of claim 1 wherein the number average molecular weight (Mn) of the polyorganosiloxane (B) is 100,000 to 400,000.

7. The thermoplastic resin composition of claim 1 wherein the polyorganosiloxane (B) is a polydimethylsiloxane homopolymer having dimethylhydroxysiloxy end groups.

8. The thermoplastic resin composition of claim 1 wherein the composition comprises 94 to 97% thermoplastic polycarbonate resin (A), and 3 to 6% polyorganosiloxane (B).

9. The thermoplastic resin composition of claim 1 wherein the composition has an average notched Izod impact strength at −40° C. of at least 133.5 J/m as determined by ASTM 256-97, Method A.

10. The thermoplastic resin composition of claim 1 wherein the composition has an average notched Izod impact strength at −40° C. of at least 267 J/m as determined by ASTM 256-97, Method A.

11. The thermoplastic resin composition of claim 1 having an average notched Izod impact strength as determined by ASTM 256-97 Method A at −40° C. that is at least 200% increased vs. the value of the thermoplastic polycarbonate resin (A) alone.

12. The thermoplastic resin composition of claim 1 having an average notched Izod impact strength as determined by ASTM 256-97 Method A at −40° C. that is at least 300% increased vs. the value of the thermoplastic polycarbonate resin (A) alone.

13. The thermoplastic resin composition of claim 1 further comprising an additive selected from fillers, lubricants, plasticizers, pigments, dyes, anti-static agents, blowing agents, heat stabilizers, and fire retardants.

14. A thermoplastic resin composition consisting essentially of;
(A) 85 to 99% of a thermoplastic polycarbonate resin,
(B) 1 to 15% of a polyorganosiloxane having the formula;
(R′₃SiO_{½})ₓ(R′₂SiO_{2/2})_{y}(R′SiO_{3/2})_{z}
wherein x and y are positive numerical values and z is 0 or a positive numerical value with the provisos that x+y+z=1, y/(x+y+z)≧0.8 and R′ is a functional or nonfunctional, substituted or unsubstituted organic group and (A)+(B) is 100.

15. A process for preparing a thermoplastic resin composition comprising:
(I) preparing a masterbatch containing
(A) 40 to 90% of a thermoplastic polycarbonate resin,
(B) 10 to 60% of a polyorganosiloxane having the formula;
(R′₃SiO_{½})ₓ(R′₂SiO_{2/2})_{y}(R′SiO_{3/2})_{z}
wherein x and y are positive numerical values and z is 0 or a positive numerical value with the provisos that x+y+z=1, y/(x+y+z)≧0.8 and R′ is a functional or nonfunctional, substituted or unsubstituted organic group and (A)+(B) is 100, and
(II) mixing the masterbatch with additional polycarbonate resin.

16. The process of claim 15 wherein the polyorganosiloxane (B) has a number average molecular weight (Mn) of at least 10,000.

17. The process of claim 15 wherein the number average molecular weight (Mn) of the polyorganosiloxane (B) is 40,000 to 400,000.

18. The process of claim 15 wherein the number average molecular weight (Mn) of the polyorganosiloxane (B) is 100,000 to 400,000.

19. The process of claim 15 wherein the polyorganosiloxane (B) is a polydimethylsiloxane homopolymer having dimethylhydroxysiloxy end groups.

20. A thermoplastic resin product prepared according to the process of claim 15.

21. A thermoplastic resin product prepared according to the process of claim 16.

22. A thermoplastic resin product prepared according to the process of claim 17.

23. A thermoplastic resin product prepared according to the process of claim 18.

24. A thermoplastic resin product prepared according to the process of claim 19.

25. An article of manufacture comprising the composition of claim 1.

26. An article of manufacture comprising the composition of claim 13.

27. An article of manufacture comprising the composition of claim 20.

28. A method for improving the impact resistance of a polycarbonate resin comprising;
(I) preparing a masterbatch containing
(A) 40 to 90% of a thermoplastic polycarbonate resin,
(B) 10 to 60% of a polyorganosiloxane having the formula;
(R′₃SiO_{½})ₓ(R′₂SiO_{2/2})_{y}(R′SiO_{3/2})_{z}
wherein x and y are positive numerical values and z is 0 or a positive numerical value with the provisos that x+y+z=1, y/(x+y+z)≧0.8, R′ is a functional or nonfunctional, substituted or unsubstituted organic group and (A)+(B) is 100, and
(II) mixing the masterbatch with additional polycarbonate resin (A).

29. The method of claim 28 wherein the masterbatch contains
45 to 55% thermoplastic polycarbonate resin (A), and
45 to 55% polyorganosiloxane (B).

30. The method of claim 28 wherein the mixing is performed in an extruder.
